(19) United States
(12) Patent Application Publication
(10) Pub. No.: US 2026/0227926 A1
(43) Pub. Date: Aug. 6, 2026

(54) Storage Controllers With Enhanced Retention Period Management

(71) Applicant: NetApp, Inc., San Jose, CA (US)

(72) Inventors: Robin Christopher Roy, Vancouver (CA); Andrea Suet Yee Chan, Vancouver (CA); Srinivas Nagarajan, Bangalore (IN); Vikrant Singh, Varanasi (IN); Kenneth Weston Winters, Apex, NC (US); Jonathan King Ho Wong, Vancouver (CA)

(73) Assignee: NetApp, Inc., San Jose, CA (US)

(21) Appl. No.: 19/184,028

(22) Filed: Apr. 21, 2025

Related U.S. Application Data
(60) Provisional application No. 63/753,601, filed on Feb. 4, 2025.

(51) Int. Cl. G06F 3/06

(52) U.S. Cl. CPC G06F 3/0655; G06F 3/0604; G06F 3/0673

(57) ABSTRACT

Methods and systems for mitigating stranded data objects in storage resources used by tenants of an application service. Techniques are disclosed for determining maximum allowable retain-until-dates for objects that have object lock features enabled such that any retain-until-date selection will not result in a stranded object. A request to configure an object lock retention period for an object or for a structure containing data objects is received. The request is associated with a tenant account, based on which a maximum value for the retain-until-date can be determined. The maximum retain-until-date is the greatest retention period that the object or structure can have while not exceeding the expiration of a service relationship associated with the tenant. Service relationships for the tenant are identified and the maximum retain-until-date is determined. Based on the maximum retain-until-date, the retain-until-date for the object can be set without the risk of the objecting becoming stranded.

### TECHNICAL FIELD

Aspects of the disclosure are related to the field of data storage solutions, and in particular, to data retention period management technology.

### BACKGROUND

Object lock is a feature in object storage systems that protects data objects from deletion or modification for a specified period. When object lock features are enabled, data objects can be made immutable (i.e., unmodifiable, and undeletable) until the expiration of a predetermined retain-until-date (also referred to as a retention date). Preserving data objects through object lock ensures that data is not lost during the retention period (i.e., before the retain-until-date expires). Object lock can be used to preserve data in order to satisfy various legal and industry-specific compliance standards.

In many scenarios, application services use object storage systems to provide various services to users (i.e., businesses or other entities). Application services use tenant accounts to track and manage the business or other entities that have purchased services and resources. A given tenant account operates independently from other tenants in the same environment, ensuring separation of data, resources, and administrative control. An administrator of an application service may enable object lock features for tenants, which allows administrators for each tenant to configure retain-until-dates for the various objects and object storage structures of the object storage resources provided by the application service.

However, problems arise from the unrestricted nature of retain-until-dates. Where object lock features are enabled in the application services, a tenant administrator may configure the retain-until-date for a given object such that the retention period exceeds a service expiration date of the application service that is associated with the tenant. In other words, a tenant administrator can establish a retain-until-date greater than the period for which the associated clients have paid for services. As a result, an application service may end up preserving a data object for a buyer that no longer has an ongoing service relationship with the application service. This problem, known as stranded data objects, consumes storage resources that could otherwise be used to store data objects for a tenant account associated with an ongoing service relationship.

In some instances, application service administrators have specialized tools that allow for the deletion of stranded objects. However, some compliance settings (e.g., a compliance mode) disable such tools. In other scenarios, an application service can ensure deletion tools remain available by globally disabling compliance features for all tenants. Unfortunately, this global strategy is disruptive to the application service, as many clients require compliance settings to be available.

### SUMMARY

Disclosed herein are methods and systems for mitigating and potentially eliminating the phenomenon of stranded data objects in the storage resources used by tenants of an application service. In particular, techniques are disclosed for determining maximum allowable retain-until-dates for data objects that have object lock features enabled such that any retain-until-date selection will not result in a stranded data object. A request to configure an object lock retention period for a data object or for a structure containing data objects is received. The request is associated with a tenant account, based on which a maximum value for the retain-until-date can be determined. The maximum retain-until-date is the greatest length of retention period that the object or structure can be configured with while not exceeding the expiration of a service relationship associated with the tenant. The relevant service relationships for the tenant are identified, and the maximum retain-until-date is determined. Based on the maximum retain-until-date, the retain-until-date for the data object can be set without the risk of stranded data objects.

This Summary introduces a selection of concepts in a simplified form that are further described below. It may be understood that this Summary is not intended to identify key features or essential features of the claimed subject matter, nor is it intended to be used to limit the scope of the claimed subject matter.

### BRIEF DESCRIPTIONS OF THE DRAWINGS

Many aspects of the disclosure may be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views. While several embodiments are described in connection with these drawings, the disclosure is not limited to the embodiments disclosed herein. On the contrary, the intent is to cover all alternatives, modifications, and equivalents.

FIG. 1 illustrates an operating environment in accordance with an implementation.

FIG. 2 illustrates a method in accordance with an implementation.

FIGS. 3A-3B illustrate various operational scenarios in accordance with an implementation.

FIG. 4 illustrates a further operating environment in accordance with an implementation.

FIG. 5 illustrates a further method in accordance with an implementation.

FIG. 6A illustrates an operational scenario in accordance with an implementation.

FIG. 6B illustrates an operational scenario in accordance with an implementation.

FIG. 7 illustrates a computing device used in accordance with several implementations.

### DETAILED DESCRIPTION

Disclosed herein are methods and systems for mitigating, and potentially eliminating, the phenomenon of stranded data objects in the storage resources used by tenants of an application service. In particular, techniques are disclosed for determining maximum allowable retain-until-dates for data objects that have object lock features enabled such that any retain-until-date selection will not result in a stranded data object. A request to configure an object lock retention period for a data object or for a structure containing data objects is received. The request is associated with a tenant account, based on which a maximum value for the retain-until-date can be determined. The maximum retain-until-date is the greatest length of retention period that the object or structure can be configured with while not exceeding the expiration of a service relationship associated with the tenant. The relevant service relationships for the tenant are identified, and the maximum retain-until-date is determined. Based on the maximum retain-until-date, the retain-until-date for the data object can be set without the risk of stranded data objects created by locked objects with lock expirations beyond the expiration of the service contract with the tenant.

For example, a tenant of an object storage service may be a business or other commercial entity that generates data and stores the data by leveraging object storage services. Continuing the example, the application service may be an object storage service that provides object storage services by utilizing the data storage resources of a storage service. In the ongoing example, the storage service may be a data storage provider. In such an example, the business (i.e., the tenant) generates data objects in the ordinary course of operation and contracts with the object storage service (i.e., the application service) to store the data objects in the storage resources provided by the data storage provider (i.e., the storage service). In some scenarios, the business becomes subject to a court order or other such requirement that directs the business to preserve some or all of its data. In response, the business interacts with the object storage service to enable object lock features for the business's data objects to make the data objects immutable for preservation. To configure the object lock features, a retain until date is configured. The application service determines the maximum allowable retain-until-date for the objects based on the expiration of the service relationship between the business and the object storage services and provides the business with options for retain-until-dates that do not exceed that maximum value. Similarly, the application service can offer to extend the contract to the desired retain-until-date or beyond ensuring that the object lock is preserved for the full length of time. The business selects one of the options, and in response, the object storage service configures the retain-until-date in accordance with the selection. The object storage service then directs the data storage provider to implement immutability for the data objects until the configured retian-until-date.

Continuing the same example but with regard to additional embodiments, there may be situations where the contractual relationship that a retain-until-date may not exceed the expiration of is not the contractual relationship between the business and the object storage service, but rather the contractual relationship between the object storage service and the data storage provider. In some instances, the object storage service purchases the data storage resources from the data storage provider and is entirely maintained by the object storage service. In other words, there is no contractual relationship between the entity providing the object storage service and the entity providing the data storage resources because they are the same entity. However, in other instances, the entity that provides the object storage service and the entity that provides the data storage resources are distinct and separate entities. In these instances, it may be possible for a configured retain-until-date entered by the business to exceed the service relationship between the object storage service and the data storage provider, resulting in potentially stranded objects from the perspective of the data storage provider. In these scenarios, the maximum allowable retain-until-date is determined based on the service relationship between the object storage service and the data storage provider. In these scenarios, the object storage service may determine the maximum retain-until-date value internally or may query the data storage provider for the maximum retain-until-date value.

In some embodiments, the tenant (i.e., a client of an application service) submits a request to configure the retention settings for a data object that includes a suggested value for the retain-until-date. In such embodiments, the suggested value for the retain-until-date may be approved or denied based on a comparison of the suggested retain-until-date and the maximum allowable value for the retain-until-date. Where the suggested retain-until-date exceeds the maximum value, the suggested retain-until-date is rejected. In some embodiments, an excessive retain-until-date is not immediately rejected. Instead, the application service queries the tenant to determine if the tenant would like to extend the service relationship such that the retain-until-date no longer extends beyond the expiration of the service relationship. If the tenant opts to extend the service relationship, the suggested retain-until-date can be used. If the tenant does not extend the service relationship, the suggested retain-until-date is rejected.

In some other embodiments where the requested retain-until-date that exceeds the service relationship is not immediately rejected, the object storage service may record the requested retain-until-date and query the tenant for renewal of the service relationship at some later date. This request may include a reminder that an object lock was requested until a desired date (or time period) and the service relationship needs to be renewed in order for continued object lock until that date (or time period). Where the tenant extends the service relationship so that the retain-until-date no longer exceeds the service relationship, the suggested retain-until-date can be automatically implemented. Where the tenant does not extend the service relationship, an earlier retain-until-date can automatically be implemented.

In some embodiments, the service client submits a request that asks to configure the retention settings for a data object but does not include any suggested value for the retain-until-date. In some such embodiments, the service provider may present multiple retention retain-until-date options to the service client. The multiple retention period end-date options are determined based on the maximum end-date value. The service client returns a selection of one of the multiple retention period end-date options, and the selection is then used to configure the retention period for the data object in the storage volume. In other embodiments, the service provider may allow for any retain-until-date before the maximum end-date value to be selected.

In some embodiments, the maximum end-date value is determined based on the expiration of a service relationship between the application service and the service client. In some embodiments, the maximum end-date value is determined based on the expiration of a service relationship between the application service and a storage vendor. In some embodiments, the maximum end-date value is based on the expiration of a service relationship between the application service and tenant, the expiration of a service relationship between the application service and storage provider, contextual information associated with the tenant account (e.g., the type of entity the tenant is, previous relationships between the application service and the tenant, and the like), or a combination thereof. In some embodiments, the contextual information can allow for automatic limited extensions of the maximum end-date value past the expiration of the service relationship. These can be tiered, derived from a custom formula, or computed in some other manner. These extensions could also be not only limited in time, but also in the maximum size of the objects that can be lock past this date. Any requests that exceed the maximum size may be granted no extensions past the end of the service date. As such, the exposure of the stranded objects should the tenant not renew the relationship is limited in duration and/or amount.

For example, the contextual information associated with the tenant account can be used to adjust or extend the maximum end date based on the contextual information. An extension could automatically be applied based on the length of the relationship. The following table illustrates an example of automatic extensions that may be granted based on the length of relationship between the service provider and the tenant:

| Length of Relationship | | Extension | | Maximum Size for Extension | |
|---|---|---|---|---|---|
| 0-2 | Years | 30 | Days | 1 | TB |
| 2-5 | Years | 60 | Days | 3 | TB |
| 5-10 | Years | 180 | Days | 10 | TB |

| | | | | |
|---|---|---|---|---|
| 10+ | Years | 365 | Days | Unlimited |

Similarly to the automatic extensions applied in tiers to the length of service, automatic extensions may also be granted based on entity types, amount of data used, number of users, dollar value of account or contract (e.g., yearly or lifetime), and the like. For example, larger institutions with high dollar spend on the relationship may be granted longer automatic extensions.

In some embodiments, the service client stores the data object in the storage volume in a governance mode. In such embodiments, tools are available for the deletion of stranded objects, and as a result, restricting the configuration of retention period end-dates is not strictly necessary to mitigate or eliminate the problem of stranded objects. In some embodiments, the service client stores the data object in the storage volume in a compliance mode. In such embodiments, the tools for the deletion of stranded objects are not available, and as a result, restricting the configuration of retention period end-dates remains an effective tool for mitigating or eliminating the problem of stranded objects.

In some embodiments, the retention period end date is a configurable setting associated with the storage volume. In such embodiments, any object stored in the storage volume is subject to the retention settings established for the storage volume. In some embodiments, the retention period end date is a configurable setting associated with the object. In such embodiments, the retention period end date is configured only for the object being stored in the storage volume.

Various embodiments of the present technology provide for a wide range of technical effects, advantages, and/or improvements to computing systems and components. For example, various embodiments may include one or more of the following technical effects, advantages, and/or improvements: 1) non-routine and unconventional implementation of techniques for granular control of object lock features on a per-tenant basis; 2) non-routine and unconventional operations for the dynamic monitoring and enforcement of retention period restrictions to prevent stranded lock objects past tenant agreements; 3) integration of granular object lock control and monitoring within all operational modalities (e.g., compliance mode, governance mode, etc.); 4) selective enablement or disablement (e.g., time restricted enablement) of object lock compliance mode on a per-tenant basis; 5) non-routine and unconventional operations allowing administrators to set maximum retention periods for objects (e.g., retention periods that do not exceed service terms agreed upon with the tenant); 6) non-routine and unconventional systems and algorithms for identification, notification, and enforcement of object lock restrictions on a per-tenant basis; 7) enhanced management tools for administrators allowing for monitoring and enforcement of object lock restrictions; 8) non-routine and unconventional operations for restricting the configuration of retain-until-dates for data objects with object lock features enabled; and 9) non-routine and unconventional implementation of techniques allowing clients of application services to configure retain-until-dates without the risk of stranding objects.

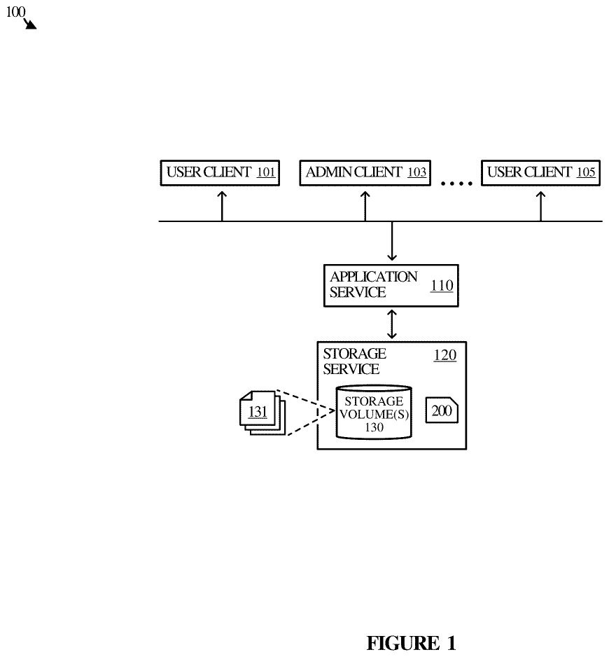

FIG. 1 illustrates operating environment 100 in accordance with an implementation. Operating environment 100 includes user client 101, administrator client 103, user client 105, application service 110, and storage service 120. Storage service 120 further includes storage volume 130 and method 200. Storage volume 130 further includes data objects 131.

Operating environment 100 is generally representative of an environment in which application service 110 leverages storage service 120 to provide user client 101, administrator client 103, and user client 105 with services. Operating environment 100 may include additional elements that are not illustrated here for clarity.

Application service 110 is generally representative of hardware, software, or firmware for leveraging storage service 120 to provide services to user client 101, administrator client 103, and user client 105. Application service 110 may be implemented with a physical computing device or with virtualized computing resources. Application service 110 is representative of any service that stores large amounts of diverse unstructured data (e.g., videos, photos, e-mails, sensor data, web content, etc.) in the storage resources of storage service 120. Examples of application service 110 include file sharing and collaboration tools, backup and disaster recovery solutions, content management systems, file system applications and services, storage applications, office productivity applications, database applications, gaming applications, e-commerce applications, and the like.

For example, application service 110 may be an object storage service offered as software as a service (SaaS) that utilizes underlying storage service 120, while user client 101 may be a commercial entity (e.g., a law firm) in need of object storage services. In such an example, user client 101 subscribes to a term of service (e.g., monthly, yearly, etc.) for object storage services from application service 110. During the term of service, user client 101 utilizes application service 110 to store, share, manage, and backup data. In some scenarios, user client 101 may be required to preserve data for a certain period of time. For instance, a court order or other legal principle may require user client 101 to preserve data as part of an ongoing legal proceeding or other governmental, adjudicative, or administrative matter. To preserve the data, user client 101 or an administrator associated with the same client entity enables object lock features of application service 110. In some cases, user client 101 may need to extend their service relationship with application service 110 in order to set a retain-until-date sufficient to comply with various requirements to preserve data.

Storage service 120 is representative of one or more computing devices configured to provide data storage services by leveraging data storage resources. Storage service 120 may be implemented in an on-prem manner, off-prem, in the cloud, in a hybrid manner distributed amongst on-prem equipment, off-prem equipment, and/or cloud computing resources. Storage service 120 may include, for example, one or more nodes that each include a storage controller and storage resources to and from which a controller may read and write data. The nodes may also include an administrative node having management and control functionality for administering the other nodes.

User client 101 is generally representative of a computing hardware and/or software client that interacts with application service 110 in order to utilize the services offered by application service 110. User client 105 is also generally representative of a computing hardware and/or software client that interacts with application service 110 in order to utilize the services offered by application service 110. User client 101 and user client 105 may each be uniquely associated with different tenant accounts of applications service 110.

Administrator client 103 is generally representative of an administrator who configures various settings and parameters of application service 110 with regard to a tenant account. Administrator client 103 may be associated with a tenant account including user client 101, a tenant account including user client 105, or a tenant account including both user client 101 and user client 105. In many different scenarios, administrator client 103 may need to preserve data. For example, data preservation may be required for compliance, security, legal holds, accidental deletion prevention, and other reasons. In particular, administrator client 103 configures object lock settings in order to preserve objects associated with the tenant account of administrator client 103. Object lock is a feature that ensures data immutability for a period of time. Object lock features may be applied to an object when the object is ingested to application service 110, in response to a legal hold, as the result of a new policy, immediately after the creation of a backup, and the like. To configure object lock features, various settings are established. For example, a retain-until-date (i.e., retention date) is set to define the length of time for which an object will be made immutable. In another example, object lock features can be enabled for an object in association with a compliance mode and a governance mode. These two modes differ with respect to object deletion, as governance mode includes a specialized delete tool that allows an administrator to delete an immutable object that would otherwise not be deletable. Compliance mode, however, lacks this specialized delete feature.

Storage volume 130 is generally representative of physical or virtual resources (e.g., solid-state drives, hard disk drives, etc.) used by storage service 120 to store data. Storage service provides a storage capability to application service 110. Storage volume 130 may be on-premises, remote, cloud-based, or a combination thereof. Storage volume 130 may represent a single physical data storage device, a number of physical storage devices, an aggregation of physical storage devices, virtual storage resources, or a combination thereof.

Data objects 131 are representative of one or more data objects held in storage volume 130 for which object lock features can be enabled and retain-until-dates can be established. Data objects 131 may include any number of data objects, each of which is associated with a tenant account. Each of the one or more data objects represented by data objects 131 may be associated with a single tenant account or may be associated with different tenant accounts.

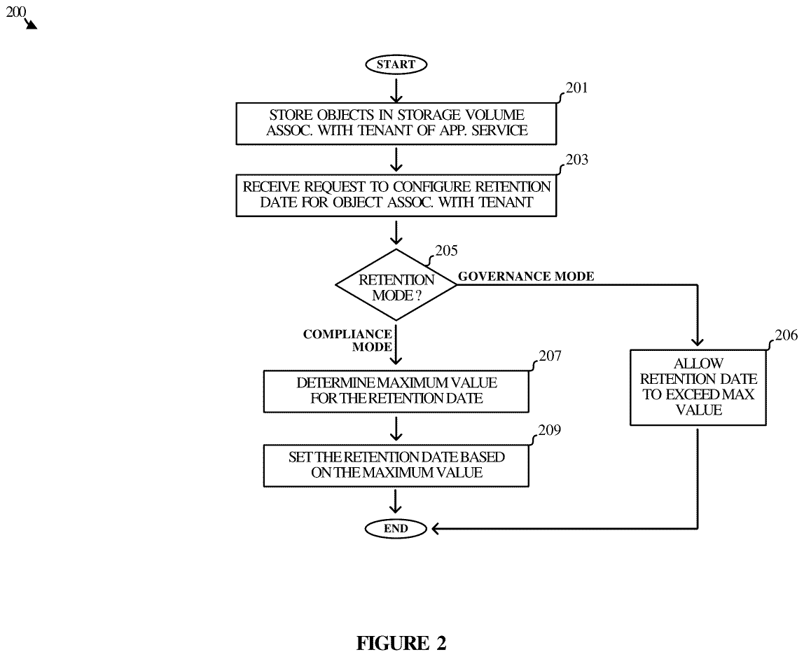

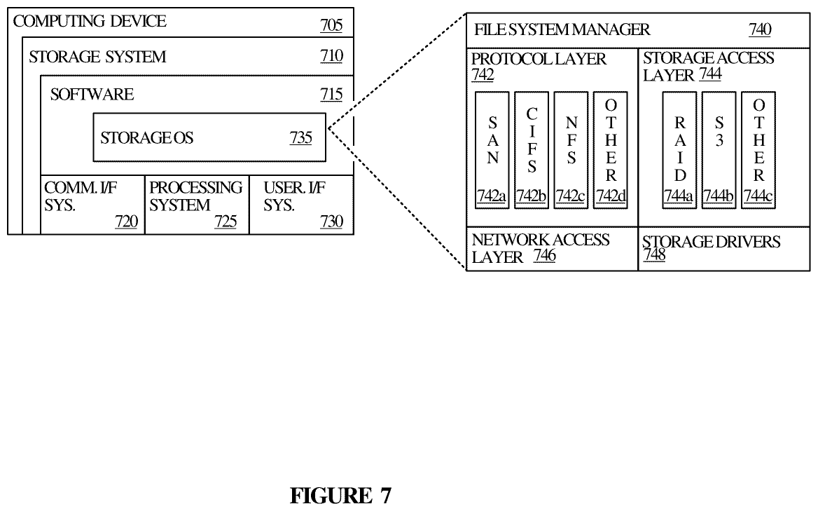

Referring now to FIG. 2, method 200 represents a process employed by an object storage service in an implementation, such as the object storage service provided by application service 110 in association with storage service 120. In some embodiments, method 200 may be implemented via application service 110, while in other embodiments, method 200 may be implemented via storage service 120. In some embodiments, method 200 is implemented via a combination of application service 110 and storage service 120. In any case, either or both application service 110 and storage service 120 employ method 200, illustrated in FIG. 2, to manage object lock configurations in response to requests supplied by user client 101. Method 200 may be implemented in executable program instructions in the context of the software and/or firmware elements of storage service 120, application service 110, or a combination thereof. The program instructions, when executed by one or more processing devices of one or more suitable computing devices (e.g., computing device 705 in FIG. 7), direct the one or more computing devices to operate as follows, referring to the steps of FIG. 2 and in the singular to a computing device for the sake of clarity.

To begin, a computing device, such as a storage controller, stores data objects in a storage volume that is associated with a tenant account of an application service (step 201). The tenant account, which may be a business, commercial entity, or other entity generating data objects, interacts with the computing device to store and manage the data objects.

The computing device receives a request from a client of the application service to configure object lock settings for one of the data objects stored by the application service (step 203). In some scenarios, object lock features are enabled for a data object at the time of ingestion, while object lock features may be enabled for a data object at some later point in other scenarios.

The request is to configure the retain-until-date for a data object. The request may have been received from a user client or from an administrator client. In some cases, the request corresponds to the object lock settings of a single data object, while in some other cases, the request corresponds to a data object storage structure (e.g., an object storage container). In some cases, the object lock settings established for a data object storage structure or container are applied to each data object held in the structure or container.

The computing device then determines whether the request to configure the object lock settings for a data object corresponds to a compliance mode or a governance mode (step 205). Generally, compliance mode provides a higher level of object protection than governance mode. Typically, an object with object lock enabled cannot be altered or deleted in compliance mode until the retention period for the object expires. In contrast, governance mode allows authorized users (e.g., administrators) to alter object lock settings or even delete objects with object lock enabled using a specialized delete tool. Where the request to configure the object lock settings for the data object is associated with a governance mode, the application service may allow a retain-until-date to be implemented despite the retain-until-date exceeding the service relationship between the application service and the tenant account associated with the client. The application service can allow excessive retain-until-dates to be configured because a specialized delete tool for removing stranded data objects is available under governance mode (step 206).

However, where the request to configure the object lock settings for the data object is associated with a compliance mode, the computing device proceeds with determining the maximum retain-until-dates to mitigate the issue of stranded data objects. The application service proceeds with maximum retain-until-date evaluation under a compliance mode because no specialized delete tools for removing stranded data objects are available.

For example, a tenant of an application service may enable object lock features under a governance mode for data objects that it wishes to protect but does not require the more significant oversight provided by a compliance mode. In another example, a tenant of an application service may enable object lock features under a compliance mode where the tenant seeks to preserve data objects with the highest standard of strictness to satisfy a legal, compliance, administrative, or other type of order directing the tenant to preserve data. In some scenarios, where object lock features have been enabled for a tenant under a governance mode, the application service allows a tenant administrator to configure retain-until-dates that exceed the service relationship between the tenant and the application service because a specialized delete tool allows the application service to delete object locked objects under governance mode. However, because compliance mode includes no specialized delete tool, the techniques for managing retain-until-dates as described herein are used when object lock features are enabled for a data object under compliance mode.

Having determined that the request to configure the object lock settings for the data object is associated with a compliance mode, the computing device determines the maximum value for the retain-until-date (step 207). The maximum value is the greatest value (i.e., the furthest out date) that the retain-until-date can be set to without exceeding a service relationship associated with the tenant and thus stranding the data object. In some embodiments, the computing device determines the maximum retain-until-date based on the service relationship. In some cases, the information indicating when a particular service relationship expires is contained in a tenant database. In such cases, an administrator of the application service loads information regarding service relationships with the tenants of the application service. Should a computing device need information regarding how long a particular tenant's service relationship extends, the computing device reads information for that particular tenant from the tenant database. In some cases, the computing device queries the tenant database in order to populate a maximum value for the retain-until-date.

In some scenarios, an administrator of a client entity may input a retain-until-date that exceeds the service relationship between an application service and the client entity. In some embodiments, the excessive retain-until-date is rejected, and another retain-until-date must be used. In some embodiments, the application service may record the excessive retain-until-date and evaluate whether the client entity has renewed its service contract to extend out to or beyond the expiration of the excessive retain-until-date. Where the service contract has been renewed, the application service can implement the retain-until-date as it is no longer excessive with respect to the newly renewed service contract between the client entity and the application service. In some embodiments, the application service may detect that an inputted retain-until-date exceeds the service relationship between an application service and the client entity and, in response, queries an administrator or other operator of the client entity to ask if the client entity would like to extend their service relationship out to or beyond the expiration of the inputted retain-until-date. Where the client entity does not wish to extend the service contract, the excessive retain-until-date can be rejected. In some embodiments, a client entity may be presented with a number of retain-until-date options, some of which are valid options under the current service relationship between the client entity and the application service and some of which would only be a valid selection in combination with an extension of the service relationship.

The computing device then sets the retain-until-date for the data object in response to the request (step 209). In some embodiments, the computing device makes the data object immutable until at least the expiration of the retain-until-date. In some cases, the computing device makes the data object immutable via the object handling protocols. In other words, the computing device leverages object lifecycle protocols that govern when objects are deleted or maintained to implement object immutability. To implement object immutability through object lifecycle protocols, the application service may configure object lifecycle protocols for an object made immutable such that the object lifecycle protocols will not delete the object before the retain-until-date for the object has expired. In some such cases, requests to delete or modify objects are blocked by the object handling protocols in which the retain-until-date information is implemented. In some cases, a data object is made immutable by virtue of a WORM (Write Once Read Many) format. Where an object is made immutable via a WORM format, the WORM status of the object may have its own distinct period of effect separate from the retention period of the data object. When object lock features are enabled for an object and the object is made into a WORM format, the computing device may implement a period during which the object remains in a WORM format such that the WORM period matches the length of the object lock retention period. The WORM period then expires at the same time the object lock features expire. As a result, the object is no longer in the WORM format upon the expiration of the object lock retention period and can thus be modified or deleted.

In some embodiments, the computing device generates a number of retain-until-date options based on the maximum retain-until-date and presents the options to the user client or administrator client that initially submitted the request. The user client or administrator client then selects one of the options, which the computing device sets as the retain-until-date for the data object. For example, the computing device may present a first option, a second option, and a maximum option. In other embodiments, the system may allow the user to select any date on or before the maximum-retain-until date.

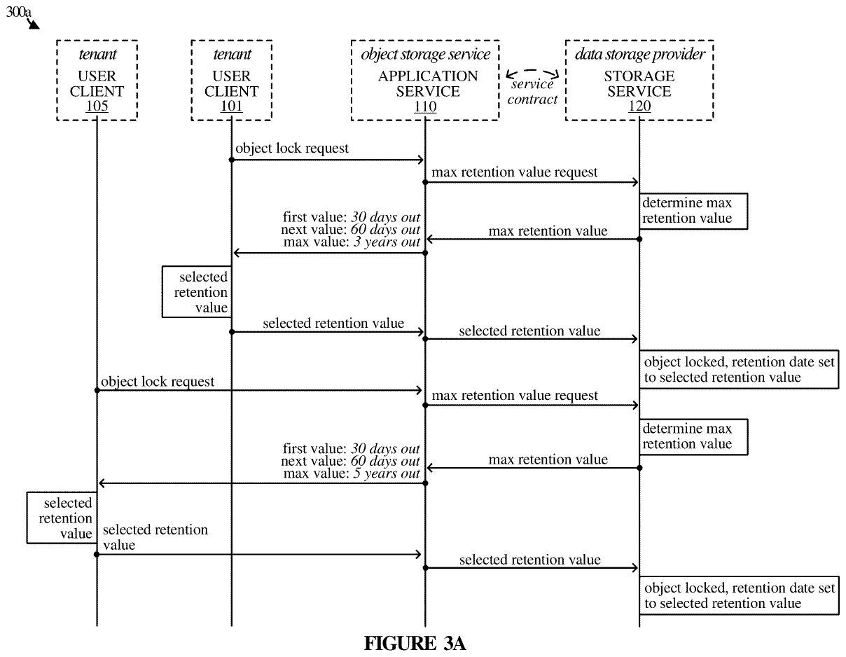

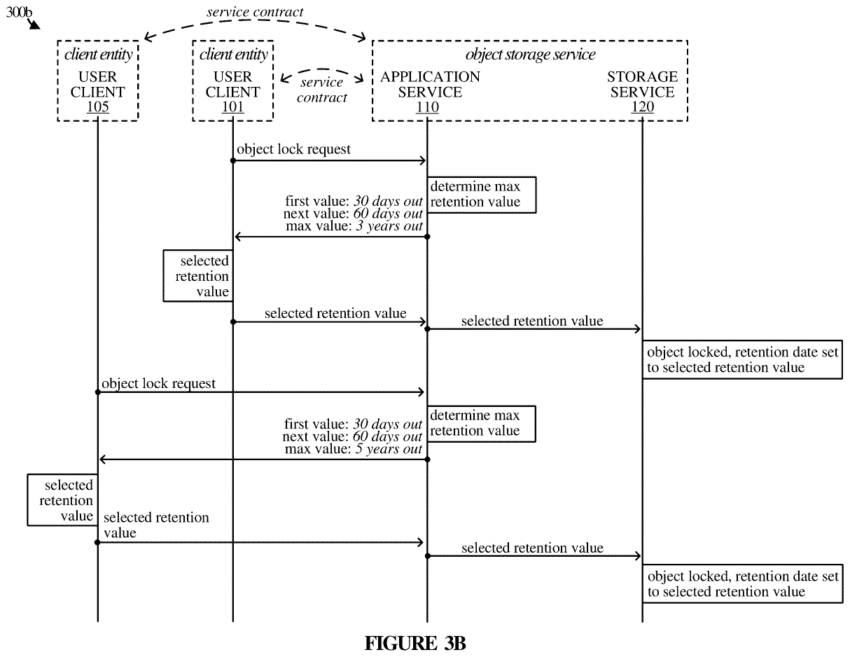

FIGS. 3A-3B illustrate higher-level operational sequences in which clients associated with tenant accounts submit requests to configure object lock features for data objects. FIG. 3A and FIG. 3B differ in that they show example operations occurring with respect to different embodiments.

FIG. 3A illustrates an example operation for an embodiment in which application service 110 (e.g., an object storage service) and storage service 120 (e.g., a data storage provider) are distinct entities. For example, this may be the case where application service 110 leases storage resources represented by storage service 120 from a cloud storage provider or from another data storage provider that provides leased data storage resources. The example operation shows application service 110 query storage service 120 for a maximum retention date value (i.e., a retain-until-date) in response to receiving a request from user client 101.

FIG. 3B illustrates an example operation for an embodiment in which application service 110 (e.g., an object storage service) and storage service 120 (e.g., a data storage provider) are elements of the same entity. This may be the case where application service 110 has purchased and independently maintains the resources of storage service 120 from an entity that builds and sells such resources. The example operation shows application service 110 independently determining the maximum retention date value (i.e., a retain-until-date) in response to receiving a request from user client 101.

FIG. 3A illustrates operational scenario 300a in accordance with an implementation that is representative of an application of method 200 in the context of FIG. 1. Operational scenario 300a includes user client 101, user client 105, application service 110, and storage service 120, each of FIG. 1, respectively. Operational scenario 300a is representative of an example scenario that may be considered with respect to the elements and method steps of FIG. 1 and FIG. 2, respectively.

Application service 110 (e.g., an object storage service) receives a request to configure object lock settings for a data object (e.g., data objects 131 of FIG. 1). The request is for the storage service to configure the retain-until-date for a data object. As illustrated here, application service 110 generates a request for a maximum retention value for the data object based on a tenant account associated with the data object. The maximum value is the greatest value (i.e., the furthest out date) that the retain-until-date can be set to without exceeding a service relationship associated with the tenant and thus stranding the data object. As shown here, the tenant relationship associated with the tenant is the service relationship between application service 110 (the object storage service for user client 101) and storage service 120 (the data storage provider for the object storage service).

Storage service 120 (e.g., data storage provider) determines the maximum retain-until-date value and returns the value to application service 110. Based on the maximum retain-until-date value, application service 110 generates a first retention value, a next retention value, and a maximum retention value. In other examples, there may be more or fewer retention values provided by application service 110. The values for the retain-until-date may be as short as days or may be on the order of weeks, months, or years. In some embodiments, an administrator of a tenant may configure the number of retain-until-dates provided by application service 110. In some embodiments, application service 110 provides fixed periods for retain-until-dates. In such embodiments, the application service may provide one or more of the fixed periods where the provided fixed periods do not extend beyond a service relationship between application service 110 and the relevant tenant.

As shown here, the first retention value is thirty days, the second retention value is sixty days, and the maximum retain-until-date is three years out. Application service 110 provides user client 101 with the first retention value, the next retention value, and the maximum retain-until-date. User client 101 selects one of the options, which is returned to application service 110. Application service 110 provides the selected retain-until-date option to storage service 120, which establishes the retain-until-date for the data object based on the selection. In some embodiments, application service 110 does not provide user client 101 with options for a retain-until-date but rather automatically implements the maximum allowable value for the retention period. In some other embodiments, application service 110 does not immediately reject a tenant's suggested retain-until-date that exceeds the length of a service relationship between the tenant and application service 110, but rather application service 110 queries the tenant to determine if the tenant would like to extend the service relationship. Where the tenant decides to extend the service relationship such that the retain-until-date no longer exceeds the service relationship, the retain-until-date can be implemented for object lock features.

Application service 110 then sets the retain-until-date for the data object in response to the request. To set the retain-until-date, application service 110 directs storage service 120 to make the data object immutable until at least the expiration of the retain-until-date. In some such cases, the storage service makes the data object immutable via the object handling protocols of the storage service. In some such cases, requests to delete or modify objects are blocked by the object handling protocols in which the retain-until-date information is implemented. In some cases, a data object is made immutable by virtue of a WORM (Write Once Read Many) format. In some cases, an administration node of the storage service is configured with the retain-until-date information. In some cases, application service 110 generates an application programming interface (API) request and submits the API request to storage service 120 in order to establish the object lock setting configurations for a data object.

Next, user client 105 submits an object lock request to application service 110. User client 105 is associated with a different tenant account of application service 110 than user client 101. As a result, the proposed retention period values may be different when compared to the values displayed for user client 101. Application service 110 generates a request for a maximum retention value for the data object based on a tenant account associated with the data object.

Storage service 120 determines the maximum retain-until-date value and returns the value to application service 110. Based on the maximum retain-until-date value, application service 110 generates a first retention value, a next retention value, and a maximum retention value. As shown here, the first retention value is thirty days, the second retention value is sixty days, and the maximum retain-until-date is five years out. Notably, the maximum retain-until-date for the tenant account associated with user client 101 is given a shorter option for the maximum retain-until-date value than user client 105. This may be because user client 105 is associated with a tenant account that has contracted with application service 110 for a longer term of service than the tenant account associated with user client 101.

Application service 110 provides user client 105 with the first retention value, the next retention value, and the maximum retain-until-date. User client 105 selects one of the options, which is returned to application service 110. Application service 110 provides the selected retain-until-date option to storage service 120, which establishes the retain-until-date for the data object based on the selection.

FIG. 3B illustrates operational scenario 300b in accordance with an implementation that is further representative of an application of method 200 in the context of FIG. 1. Operational scenario 300b includes user client 101, user client 105, application service 110, and storage service 120, each of FIG. 1, respectively. Operational scenario 300b is representative of an example scenario that may be considered with respect to the elements and method steps of FIG. 1 and FIG. 2, respectively.

Application service 110 receives a request from user client 101 to configure object lock settings for a data object (e.g., data objects 131 of FIG. 1). The request is to configure the retain-until-date for a data object. As illustrated here, application service 110 receives the request and determines a maximum retention value for the data object based on a tenant account associated with the data object. The maximum value is the greatest value (i.e., the furthest out date) that the retain-until-date can be set to without exceeding a service relationship associated with the tenant and thus stranding the data object. As shown here, the tenant relationship associated with the tenant is the service relationship between user client 101 (i.e., the tenant) and application service 110 (the object storage service for user client 101).

Based on the maximum retain-until-date value, application service 110 generates a first retention value, a next retention value, and a maximum retention value. As shown here, the first retention value is thirty days, the second retention value is sixty days, and the maximum retain-until-date is three years out. Application service 110 provides user client 101 with the first retention value, the next retention value, and the maximum retain-until-date. User client 101 selects one of the options, which is returned to application service 110. Application service 110 provides the selected retain-until-date option to storage service 120, which establishes the retain-until-date for the data object based on the selection.

Application service 110 then sets the retain-until-date for the data object in response to the request. To set the retain-until-date, application service 110 directs storage service 120 to make the data object immutable until at least the expiration of the retain-until-date. In some such cases, the storage service makes the data object immutable via the object handling protocols of the storage service. In some such cases, requests to delete or modify objects are blocked by the object handling protocols in which the retain-until-date information is implemented. In some cases, a data object is made immutable by virtue of a WORM (Write Once Read Many) format. In some cases, an administration node of the storage service is configured with the retain-until-date information. In some cases, application service 110 generates an application programming interface (API) request and submits the API request to storage service 120 in order to establish the object lock setting configurations for a data object.

Next, user client 105 submits an object lock request to application service 110. User client 105 is associated with a different tenant account of application service 110 than user client 101. As a result, the proposed retention period values may be different when compared to the values displayed for user client 101. Application service 110 determines the maximum retention value (i.e., retain-until-date).

Based on the maximum retain-until-date value, application service 110 generates a first retention value, a next retention value, and a maximum retention value. As shown here, the first retention value is thirty days, the second retention value is sixty days, and the maximum retain-until-date is five years out. Notably, the maximum retain-until-date for the tenant account associated with user client 101 is given a shorter option for the maximum retain-until-date value than user client 105. This may be because user client 105 is associated with a tenant account that has contracted with application service 110 for a longer term of service than the tenant account associated with user client 101.

Application service 110 provides user client 105 with the first retention value, the next retention value, and the maximum retain-until-date. User client 105 selects one of the options, which is returned to application service 110. Application service 110 provides the selected retain-until-date option to storage service 120, which establishes the retain-until-date for the data object based on the selection.

Here, upon receiving the object lock request (i.e., the request to configure the retain-until-date for a data object), application service 110 determines the maximum retain-until-date value without having directed storage service 120 to populate the value. In some cases, application service 110 queries a tenant database for information that indicates when various service relationships of each tenant expire. Based on the information in the tenant database, application serviced 110 determines the maximum retention value.

Based on the maximum retain-until-date value, application service 110 generates a first retention value, a next retention value, and a maximum retention value. Application service 110 provides administrator client 103 with the first retention value, the next retention value, and the maximum retain-until-date. Administrator client 103 selects one of the options, which is returned to application service 110. Application service 110 provides the selected retain-until-date option to storage service 120, which establishes the retain-until-date for the data object based on the selection.

Application service 110 then sets the retain-until-date for the data object in response to the request. To set the retain-until-date, application service 110 directs storage service 120 to make the data object immutable until at least the expiration of the retain-until-date. In some such cases, the storage service makes the data object immutable via the object handling protocols of the storage service. In some such cases, requests to delete or modify objects are blocked by the object handling protocols in which the retain-until-date information is implemented. In some cases, a data object is made immutable by virtue of a WORM (Write Once Read Many) format. In some cases, an administration node of the storage service is configured with the retain-until-date information. In some cases, application service 110 generates an application programming interface (API) request and submits the API request to storage service 120 in order to establish the object lock setting configurations for a data object.

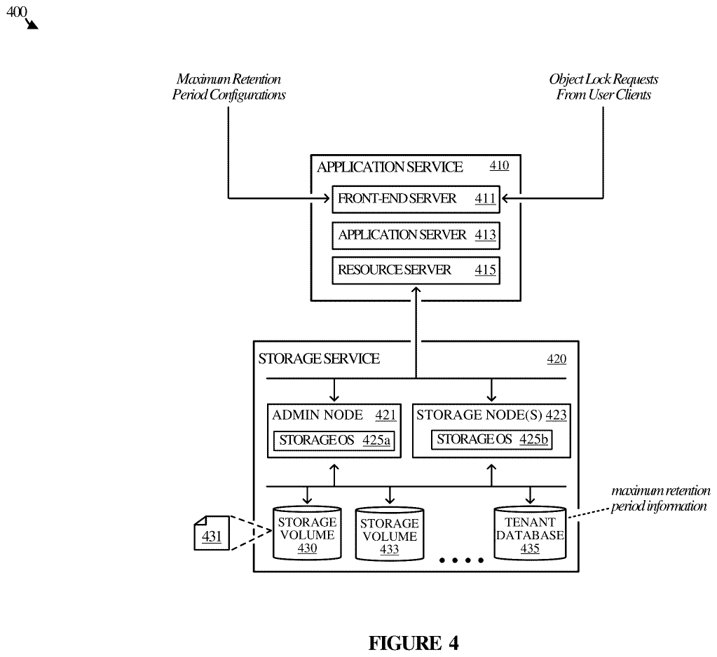

FIG. 4 illustrates further operating environment 400 in accordance with an implementation, hereinafter referred to as environment 400. Environment 400 includes application service 410 and storage service 420. Application service 410 further includes front-end server 411, application server 413, and resource server 415. Storage service 420 further includes administration node 421, storage node 423, storage volume 430, storage volume 433, and tenant database 435. Administration node 421 further includes storage operating system 425a. Storage node 423 further includes storage operating system 425b. Storage volume 430 further includes data object 431.

Environment 400 is generally representative of an environment in which application service 410 leverages storage service 420 to provide user clients (e.g., user client 101, user client 105) and administrator clients (e.g., administrator client 103) with services. Environment 400 may include additional elements that are not illustrated here for clarity.

Application service 410 is generally representative of hardware, software, or firmware for leveraging storage service 420 to provide services to user clients and administrator clients. Application service 110 may be implemented with a physical computing device or with virtualized computing resources. Application service 110 may be a cloud-based application. Front-end server 411 is representative of hardware, software, or firmware for interfacing with user clients and administrator clients. In some cases, front-end server 411 may be implemented in program code that, when executed by a processing element of application service 410, provides user clients and administrator clients with a means to interface with application service 110. In some cases, front-end server 411 provides a storage application user interface.

Storage service 420 is representative of a service that provides data storage resources. Storage service 420 may be physical data storage resources or virtual data storage resources. Storage service 420 may include a number of nodes, some of which may be administrative nodes while others are storage nodes. Administrative node 421 is generally representative of an interconnected node of storage service 420 that can be leveraged to provide computing resources to users of storage service 420. Similarly, storage node 423 is generally representative of an interconnected node of storage service 420 that can be leveraged to provide computing resources to users of storage service 420.

Storage operating system 425a and storage operating system 425b are each representative of software designed to manage and optimize storage hardware, enabling data access, organization, protection, and performance across storage devices and connected systems.

Storage volume 430 and storage volume 433 are each representative of logically defined storage space within a physical or virtual storage system that is allocated for use by applications, operating systems, or users to store and manage data. In particular, storage volume 430 and storage volume 433 are both allocated for use by application service 410. Data object 431 is representative of a data object for which object lock settings can be configured. Tenant database 435 is representative of a data structure sufficient to hold service relationship expiration information for each tenant associated with application service 410.

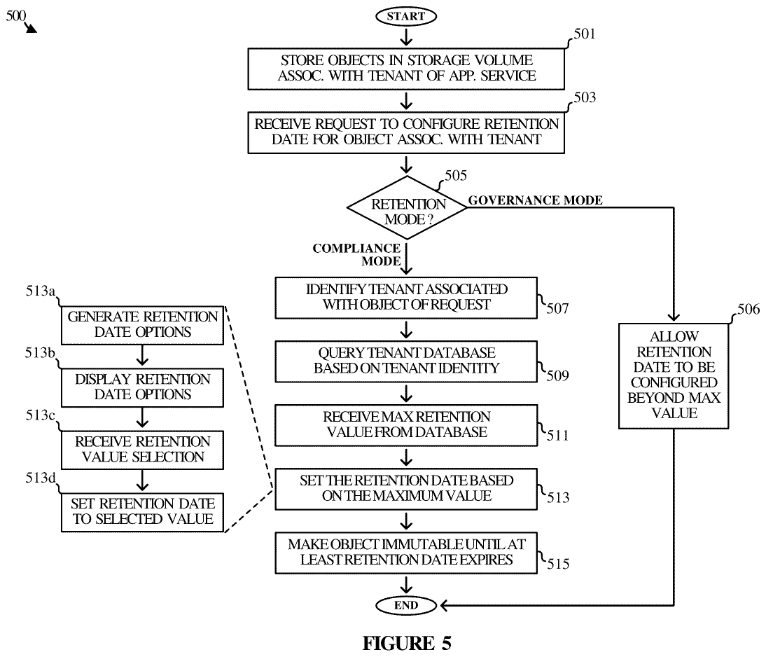

FIG. 5 illustrates method 500 in accordance with an embodiment. Storage service 420, in cooperation with a user client (e.g., user client 101) and application service 410, employs method 500, illustrated in FIG. 5, to manage object lock configurations in response to requests supplied by the user client. Method 500 may be implemented in program instructions in the context of the software and/or firmware elements of storage service 420, application service 410, or a combination thereof. The program instructions, when executed by one or more processing devices of one or more suitable computing devices, direct the one or more computing devices to operate as follows, referring to the steps of FIG. 5 and in the singular to a computing device for the sake of clarity. Further, method 500 may be implemented by processing system 725 of FIG. 7 executing storage operating system 735 of FIG. 7, and in particular, by processing system 725 executing S3 744b of FIG. 7.

To begin, a computing device, such as a storage controller, implements an application service that stores data objects in a storage volume associated with a tenant account of an application service (step 501). The tenant account, which may be a business, commercial entity, or other entity generating data objects, interacts with the computing device to store and manage the data objects.

The computing device receives a request from a client of the application service to configure object lock settings for one of the data objects stored by the application service (step 503). In some scenarios, object lock features are enabled for a data object at the time of ingestion, while object lock features may be enabled for a data object at some later point in other scenarios.

The request is to configure the retain-until-date for a data object. The request may have been received from a user client or from an administrator client. In some cases, the request corresponds to the object lock settings of a single data object, while in some other cases, the request corresponds to a data object storage structure (e.g., an object storage container). In some cases, the object lock settings established for a data object storage structure or container are applied to each data object held in the structure or container.

The computing device then determines whether the request to configure the object lock settings for a data object corresponds to a compliance mode or a governance mode (step 505). Generally, compliance mode provides a higher level of object protection than governance mode. Typically, an object with object lock enabled cannot be altered or deleted in compliance mode until the retention period for the object expires. In contrast, governance mode allows authorized users (e.g., administrators) to alter object lock settings or even delete objects with object lock enabled using a specialized delete tool. Where the request to configure the object lock settings for the data object is associated with a governance mode, the application service may allow a retain-until-date to be implemented despite the retain-until-date exceeding the service relationship between the application service and the tenant account associated with the client. The application service can allow excessive retain-until-dates to be configured because a specialized delete tool for removing stranded data objects is available under governance mode (step 506).

However, where the request to configure the object lock settings for the data object is associated with a compliance mode, the computing device proceeds with determining the maximum retain-until-dates to mitigate the issue of stranded data objects. The application service proceeds with maximum retain-until-date evaluation under a compliance mode because no specialized delete tools for removing stranded data objects are available.

Having determined that the request to configure the object lock settings for the data object is associated with a compliance mode, the computing device then identifies a tenant associated with the object of the request (step 507). The tenant may be identified in the request received at the computing device. In some scenarios, the computing device may identify the tenant by identifying a tenant associated with the volume corresponding to the data object of the request. The maximum value is the greatest value (i.e., the furthest out date) that the retain-until-date can be set to without exceeding a service relationship associated with the tenant and thus stranding the data object. The computing device then queries a tenant database in order to determine a maximum retain-until-date based on the tenant's identity. To determine the maximum retain-until-date, the computing device identifies an expiration for the service relationship between the tenant and the application service (step 509). In some cases, the computing device retrieves an expiration date from the tenant database and determines a maximum retain-until-date based on the expiration date. In some cases, the tenant database includes maximum retain-until-date and returns the relevant maximum retain-until-date to the computing device (step 511).

The computing device then sets the retain-until-date for the data object in accordance with the previously identified maximum retain-until-date (step 513). In some embodiments, the retain-until-date (or maximum end-date value) can based on the expiration of a service relationship between the application service and tenant, the expiration of a service relationship between the application service and storage provider, contextual information associated with the tenant account (e.g., the type of entity the tenant is, previous relationships between the application service and the tenant, and the like), or a combination thereof. In some embodiments, the contextual information can allow for automatic limited extensions of the maximum end-date value past the expiration of the service relationship. These can be tiered, derived from a custom formula, or computed in some other manner. These extensions could also be not only limited in time, but also in the maximum size of the objects that can be lock past this date. Any requests that exceed the maximum size may be granted no extensions past the end of the service date. As such, the exposure of the stranded objects should the tenant not renew the relationship is limited in duration and/or amount.

For example, the contextual information associated with the tenant account can be used to adjust or extend the maximum end date based on the contextual information. An extension could automatically be applied based on the length of the relationship. Similarly to the automatic extensions applied in tiers to the length of service, automatic extensions may also be granted based on entity types, amount of data used, number of users, dollar value of account or contract (e.g., yearly or lifetime), and the like. For example, larger institutions with high dollar spend on the relationship may be granted longer automatic extensions.

To execute step 513, the computing device performs several constituent steps. First, the computing device generates retain-until-date options, none of which exceed the maximum retain-until-date (step 513a). The computing device then displays the retain-until-date options to provide the tenant with the opportunity to select one of the options (step 513b). The computing device may display the retain-until-date options (or maximum retain-until date option) via a graphical user interface. The tenant selects one of the retain-until-date options (or any date before maximum retain-until date option) and returns the selection to the computing device (step 513c). Based on the selection, the computing device then sets the retain-until-date in accordance with the selected value (step 513d). To enforce the object lock features that are enabled until the retain-until-date expires, the computing device makes the objects of the request immutable until the retain-until-date has passed (step 515).

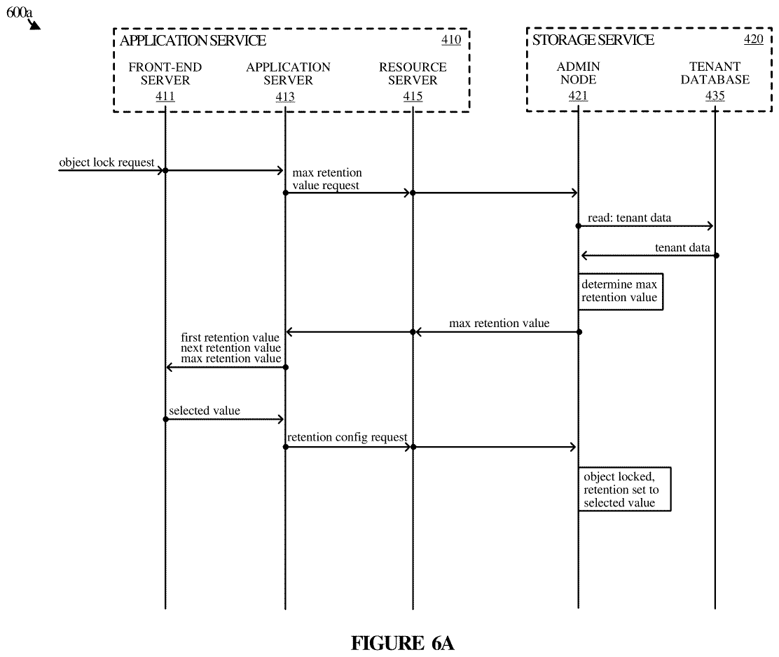

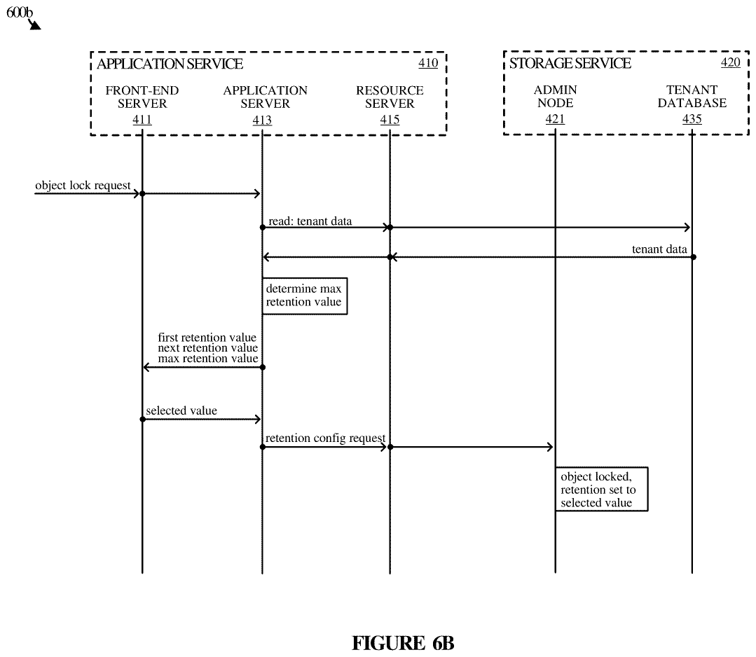

FIGS. 6A-6B illustrate more detailed operational sequences in which clients associated with tenant accounts submit requests to configure object lock features for data objects. FIG. 6A and FIG. 6B differ in that they show example operations occurring with respect to different embodiments.

FIG. 6A illustrates an example operation for an embodiment in which application service 410 (e.g., an object storage service) leverages storage service 420 (e.g., a data storage provider) in order to determine maximum retain-until-dates for objects with object lock features enabled. Here, application service 410 and storage service 420 are elements of a single entity, as storage service 420 maintains tenant database 435. In some other embodiments, tenant database 435 may be hosted by application service 410 or by another entity.

FIG. 6B illustrates an example operation for an embodiment in which application service 410 (e.g., an object storage service) leverages storage service 420 (e.g., a data storage provider) only to store data objects and not to determine maximum retain-until-dates for objects with object lock features enabled. Here, application service 410 and storage service 420 are elements of a single entity, as storage service 420 maintains tenant database 435. In some other embodiments, tenant database 435 may be hosted by application service 410 or by another entity.

FIG. 6A illustrates operational scenario 600a in accordance with an implementation. Operational scenario 600a includes front-end server 411, application server 413, resource server 415, administrative node 421, and tenant database 435, each of FIG. 4, respectively. Operational scenario 600a is representative of an example scenario that may be considered with respect to the elements and method steps of FIG. 4 and FIG. 5, respectively.

Front-end server 411 receives an object lock request. The object lock request may be received from a user client (e.g., user client 101 of FIG. 1), an administrative client (e.g., administrative client 103 of FIG. 1), or from any other client of application service 410. Front-end server 411 transmits the object lock request to application server 413 for processing. Application server 413, having received the object lock request, evaluates the request to determine how to respond. Here, the request includes a request to configure the retention period (i.e., setting the retain-until-date) for a data object.

Application server 413 generates a maximum retention value request and transmits the request to resource server 415. Resource server 415 interacts with storage service 420 in order to utilize the data storage resources therein. Resource server 415 transmits the request for the maximum retention value to administrative node 421 of storage service 420. Administrative node 421 receives the request and reads tenant data from tenant database 435 in response. In some cases, the information read from tenant database 435 includes expiration dates for service relationships associated with the tenant that corresponds to the client who submitted the initial object lock request to front-end server 411.

Administrative node 421 reads the tenant data and determines a maximum retention value based on the tenant data. Administrative node 421 transmits the maximum retention value back to application server 413 via resource server 415. Application server 413 receives the maximum retention value. In some cases, application server 413 sets the retention value to the maximum value received from administrative node 421. As shown in FIG. 6A, application server 413 uses the maximum retention value to inform the generation of a first retention value option, a second retention value option, and a maximum retention value option. Each of the three options is then transmitted to front-end server 411, which provides the options to the client that initially submitted the object lock request.

The client makes a selection, which is returned to application server 413 via front-end server 411. Application server 413 then submits the selected retention value to administrative node 421 via resource server 415. Application server 413 submits the selected retention value along with a request that the administrative node implement the requested and validated retention period with regard to the data object corresponding to the object lock request. In response, administrative node 421 applies object lock to the data object and sets the retention period (i.e., the retain-until-date) to the selected value.

FIG. 6B illustrates operational scenario 600b in accordance with an implementation. Operational scenario 600b includes front-end server 411, application server 412, resource server 415, administrative node 421, and tenant database 435, each of FIG. 4, respectively. Operational scenario 600b is representative of an example scenario that may be considered with respect to the elements and method steps of FIG. 4 and FIG. 5, respectively. Operational scenario 600b is substantively the same and includes the same elements as operational scenario 600a except that, as shown in operational scenario 600b, application server 413 is responsible for determining the maximum retention value.

Once the object lock request is received via front-end server 411, application server 413 reads tenant data from tenant database 435. Application server 413 submits a read request to tenant database 435 via resource server 415, which responds with the requested tenant data corresponding to the client who initially submitted the object lock request. Application server 413 receives the tenant data via resource server 415 and determines the maximum retention value based on the tenant data and the tenant account corresponding to the object lock request.

Application server 413 uses the maximum retention value to inform the generation of a first retention value option, a second retention value option, and a maximum retention value option. Each of the three options is then transmitted to front-end server 411, which provides the options to the client that initially submitted the object lock request.

The client makes a selection, which is returned to application server 413 via front-end server 411. Application server 413 then submits the selected retention value to administrative node 421 via resource server 415. Application server 413 submits the selected retention value along with a request that the administrative node implement the requested and validated retention period with regard to the data object corresponding to the object lock request. In response, administrative node 421 applies object lock to the data object and sets the retention period (i.e., the retain-until-date) to the selected value.

FIG. 7 illustrates computing device 705, which is representative of any system or collection of systems in which the various applications, processes, services, and scenarios disclosed herein may be implemented. Examples of computing apparatus illustrated by computing device 705 include, but are not limited to server computers, web servers, cloud computing platforms, and data center equipment, as well as any other type of physical or virtual server machine, container, and any variation or combination thereof. In some examples, computing device 705 may also be representative of desktop and laptop computers, tablet computers, and the like.

In some cases, computing device 705 is representative of a storage controller in a data storage system. In such cases, storage operating system 735 is representative of a generic example of an operating system of a storage controller. In one example, storage operating system 735 may include several modules, or “layers” executed by one or both of a network module and a storage module. These layers include a file system manager 740 that keeps track of a hierarchical structure of the stored data and manages read/write operation, i.e., executes read/write operation on storage in response to I/O requests, as described above in detail. In some cases, file system manager 740 interfaces with a failover module during a failover operation to enable access to storage managed by a failed storage system node via a partner storage system node.

Storage operating system 735 may also include a protocol layer 742 and an associated network access layer 746, to allow storage nodes to communicate over a network with other systems, such as user client 101, administrator client 103, and user client 105, each of FIG. 1. Protocol layer 742 may implement one or more of various higher-level network protocols, such as SAN (e.g., iSCSI) (742a), CIFS (742b), NFS (742c), Hypertext Transfer Protocol (HTTP) (not shown), TCP/IP (not shown) and others (742d).

Network access layer 746 may include one or more drivers, which implement one or more lower-level protocols to communicate over the network, such as Ethernet. Interactions between host systems and mass storage devices are illustrated schematically as a path, which illustrates the flow of data through storage operating system 735.

The storage operating system 735 may also include a storage access layer 744 and an associated storage driver layer 748 to allow a storage controller to communicate with a storage device. The storage access layer 744 may implement a higher-level storage protocol, such as RAID (744a), a S3 layer 744b to access a capacity tier for object-based storage (not shown), and other layers 744c. In particular, method 200 is representative of at least a portion of an execution of S3 layer 744b by processing system 725. The storage driver layer 748 may implement a lower-level storage device access protocol, such as Fibre Channel or SCSI. The storage driver layer 748 may maintain various data structures (not shown) for storing information regarding storage volume, aggregate and various storage devices.

As used herein, the term “storage operating system” generally refers to the computer-executable code operable on a computer to perform a storage function that manages data access and may, in the case of a storage system node, implement data access semantics of a general-purpose operating system. The storage operating system can also be implemented as a microkernel, an application program operating over a general-purpose operating system, or as a general-purpose operating system with configurable functionality, which is configured for storage applications as described herein.

In addition, it will be understood to those skilled in the art that the disclosure described herein may apply to any type of special-purpose (e.g., file server, filer or storage serving appliance) or general-purpose computer, including a standalone computer or portion thereof, embodied as or including a storage system. Moreover, the teachings of this disclosure can be adapted to a variety of storage system architectures including, but not limited to, a network-attached storage environment, a storage area network and a storage device directly attached to a client or host computer. The term “storage system” should therefore be taken broadly to include such arrangements in addition to any subsystems configured to perform a storage function and associated with other equipment or systems. It should be noted that while this description is written in terms of a write any-where file system, the teachings of the present disclosure may be utilized with any suitable file system, including a write-in-place file system.

Computing device 705 may be implemented as a single apparatus, system, or device or may be implemented in a distributed manner as multiple apparatuses, systems, or devices. Computing device 705 includes, but is not limited to, processing system 725, storage system 710, software 715, communication interface system 720, and user interface system 730. Processing system 725 is operatively coupled with storage system 710, communication interface system 720, and user interface system 730.

Processing system 725 loads and executes software 715 from storage system 710. Software 715 includes and implements storage processes 735, which is representative of the processes discussed with respect to the preceding Figures. When executed by processing system 725, software 715 directs processing system 725 to operate as described herein for at least the various processes, operational scenarios, and sequences discussed in the foregoing implementations. Computing device 705 may optionally include additional devices, features, or functionality not discussed for purposes of brevity.

Referring still to FIG. 7, processing system 725 may include a micro-processor and other circuitry that retrieves and executes software 715 from storage system 710. Processing system 725 may be implemented within a single processing device but may also be distributed across multiple processing devices or sub-systems that cooperate in executing program instructions. Examples of processing system 725 include general purpose central processing units, microcontroller units, graphical processing units, application specific processors, integrated circuits, application specific integrated circuits, and logic devices, as well as any other type of processing device, combinations, or variations thereof.

Storage system 710 may comprise any computer readable storage media readable by processing system 725 and capable of storing software 715. Storage system 710 may include volatile and nonvolatile, removable, and non-removable media implemented in any method or technology for storage of information, such as computer readable instructions, data structures, program modules, or other data. Examples of storage media include random access memory, read only memory, magnetic disks, optical disks, flash memory, virtual memory and non-virtual memory, magnetic cassettes, magnetic tape, magnetic disk storage or other magnetic storage devices, or any other suitable storage media. In no case is the computer readable storage media a propagated signal. Storage system 710 may be implemented as a single storage device but may also be implemented across multiple storage devices or sub-systems co-located or distributed relative to each other. Storage system 710 may comprise additional elements, such as a controller, capable of communicating with processing system 725 or possibly other systems.

Software 715 (including storage processes 735) may be implemented in program instructions and among other functions may, when executed by processing system 725, direct processing system 725 to operate as described with respect to the various operational scenarios, sequences, and processes illustrated herein.

In particular, the program instructions may include various components or modules that cooperate or otherwise interact to carry out the various processes and operational scenarios described herein. The various components or modules may be embodied in compiled or interpreted instructions, or in some other variation or combination of instructions. The various components or modules may be executed in a synchronous or asynchronous manner, serially or in parallel, in a single threaded environment or multi-threaded, or in accordance with any other suitable execution paradigm, variation, or combination thereof. Software 715 may include additional processes, programs, or components, such as operating system software, virtualization software, or other application software. Software 715 may also comprise firmware or some other form of machine-readable processing instructions executable by processing system 725.

In general, software 715, when loaded into processing system 725 and executed, transforms a suitable apparatus, system, or device (of which computing device 705 is representative) overall from a general-purpose computing system into a special-purpose computing system customized to support storage processes as described herein. Indeed, encoding software 715 on storage system 710 may transform the physical structure of storage system 710. The specific transformation of the physical structure may depend on various factors in different implementations of this description. Examples of such factors may include, but are not limited to, the technology used to implement the storage media of storage system 710 and whether the computer-storage media are characterized as primary or secondary storage, as well as other factors.

For example, if the computer readable storage media are implemented as semiconductor-based memory, software 715 may transform the physical state of the semiconductor memory when the program instructions are encoded therein, such as by transforming the state of transistors, capacitors, or other discrete circuit elements constituting the semiconductor memory. A similar transformation may occur with respect to magnetic or optical media. Other transformations of physical media are possible without departing from the scope of the present description, with the foregoing examples provided only to facilitate the present discussion.

Communication interface system 720 may include communication connections and devices that allow for communication with other computing systems (not shown) over communication networks (not shown). Examples of connections and devices that together allow for inter-system communication may include network interface cards, antennas, power amplifiers, RF circuitry, transceivers, and other communication circuitry. The connections and devices may communicate over communication media to exchange communications with other computing systems or networks of systems, such as metal, glass, air, or any other suitable communication media. The aforementioned media, connections, and devices are well known and need not be discussed at length here.

Communication between computing device 705 and other computing systems (not shown), may occur over a communication network or networks and in accordance with various communication protocols, combinations of protocols, or variations thereof. Examples include intranets, internets, the Internet, local area networks, wide area networks, wireless networks, wired networks, virtual networks, software defined networks, data center buses and backplanes, or any other type of network, combination of network, or variation thereof. The aforementioned communication networks and protocols are well known and need not be discussed at length here.

As will be appreciated by one skilled in the art, aspects of the present invention may be embodied as a system, method, or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Indeed, the included descriptions and figures depict specific embodiments to teach those skilled in the art how to make and use the best mode. For the purpose of teaching inventive principles, some conventional aspects have been simplified or omitted. Those skilled in the art will appreciate variations from these embodiments that fall within the scope of the disclosure. Those skilled in the art will also appreciate that the features described above may be combined in various ways to form multiple embodiments. As a result, the invention is not limited to the specific embodiments described above, but only by the claims and their equivalents.

What is claimed is:

1. A method for managing object retention in storage systems, the method comprising:
storing objects in a storage volume associated with a tenant of an application service;
receiving a request to configure a retention date for at least an object in the storage volume associated with the tenant of the application service;
determining a maximum value for the retention date based on a service-expiration date between the tenant and the application service;
setting the retention date based on the maximum value; and
making the object in the storage volume immutable until at least the retention date.

2. The method of claim 1, wherein an immutable object is an object that cannot be modified and cannot be deleted, and wherein making the object in the storage volume immutable until at least the retention date comprises prohibiting the object from being changed.

3. The method of claim 1, wherein determining the maximum value for the retention date is performed by an application server that provides the application service or by a storage controller that provides the storage volume to the application service.

4. The method of claim 1, wherein setting the retention date based on the maximum value is performed by an application server that provides the application service or by a storage controller that provides the storage volume to the application service.

5. The method of claim 1, wherein setting the retention date based on the maximum value comprises:
presenting, to the tenant, one or more retention date options less than or equal to the maximum value for the retention date,
receiving a selection of one of the one or more retention date options, and
setting the retention date based on the selection.

6. The method of claim 1, wherein:
the method further comprises maintaining, for the tenant, contextual tenancy information comprising at least one or more of an entity type of the tenant and previous relationships between the application service and the tenant; and
determining the maximum value for the retention date further comprises determining the maximum value for the retention date based on the contextual tenancy information.

7. The method of claim 6, wherein setting the retention date based on the maximum value comprises:
determining to provide the tenant with an extension based on the contextual tenancy information for the tenant, wherein the extension is a period of time beyond the service-expiration date during which the retention date is permitted to expire.

8. The method of claim 1, wherein:
the storage volume comprises one or more object storage containers,
the one or more object storage containers comprise one or more object storage buckets for which an object lock feature is enabled, and
the object lock feature comprises configurable settings for blocking deletion and modification of the object.

9. A computing device, comprising:
one or more computer readable storage media;
one or more processors operatively coupled with the one or more computer readable storage media; and
a data storage system comprising program instructions stored on the one or more computer readable storage media, wherein the program instructions, when executed by the one or more processors, direct the computing device to at least:
receive a request to configure an object lock retention date for at least an object in a storage volume associated with a tenant of an application service, wherein a storage service hosts the storage volume,
determine a maximum value for the object lock retention date based on a service-expiration date associated with a tenancy of the tenant with respect to the application service, and
setting the object lock retention date based on the maximum value.

10. The computing device of claim 9, wherein the program instructions further comprise instructions that, when executed, direct the computing device to make the object in the storage volume immutable until at least the object lock retention date, wherein an immutable object is an object that cannot be modified and cannot be deleted.

11. The computing device of claim 9, wherein the program instructions directing the computing device to determine the maximum value for the object lock retention date further comprises instructions that, when executed, direct the computing device to determine the maximum value for the object lock retention date at the application service or at the storage service.

12. The computing device of claim 9, wherein the program instructions directing the computing device to set the object lock retention date based on the maximum value further comprises instructions that, when executed, direct the computing device to set the object lock retention date based on the maximum value by the application service or the storage service.

13. The computing device of claim 9, wherein the program instructions directing the computing device to determine the maximum value for the object lock retention date based on the service-expiration date further comprises instructions that, when executed, direct the computing device to determine an expiration date of the tenancy and set the maximum value for the object lock retention date to no greater than the expiration date.

14. The computing device of claim 9, wherein the program instructions directing the computing device to set the object lock retention date based on the maximum value further comprise instructions that, when executed, direct the computing device to:
provide one or more object lock retention date options, wherein the one or more object lock retention date options include at least the maximum value for the object lock retention date,
receive a selection of one of the one or more object lock retention date options, and
set the object lock retention date based on the selection.

15. The computing device of claim 9, wherein:
the program instructions further comprise instructions that, when executed, direct the computing device to maintain, for the tenant, contextual tenancy information comprising one or more of an entity type of the tenant and previous relationships between the application service and the tenant; and
the program instructions directing the computing device to determine the maximum value for the object lock retention date further comprise instructions that, when executed, direct the computing device to determine a maximum value for the object lock retention date further based on the contextual tenancy information.

16. The computing device of claim 15, wherein the program instructions directing the computing device to set the retention date based on the maximum value further comprise instructions that, when executed, direct the computing device to determine to provide the tenant with an extension based on the contextual tenancy information for the tenant, wherein the extension is a period of time beyond the service-expiration date during which the retention date is permitted to expire.

17. One or more computer readable storage media having program instructions stored thereon that, when executed by one or more processors in a computing device, direct the computing device to at least:
receive a request to configure a retention date for at least an object in a storage volume associated with a tenant of an application service, and wherein a storage service hosts the storage volume,
determine a maximum value for the retention date based on a service-expiration date associated with a tenancy of the tenant with respect to the application service, and
setting the retention date based on the maximum value.

18. The one or more computer readable storage media of claim 17, wherein the program instructions further comprise instructions that, when executed, direct the computing device to:
make the object in the storage volume immutable until at least the retention date, wherein an immutable object is an object that cannot be modified and cannot be deleted.

19. The one or more computer readable storage media of claim 17, wherein:
the program instructions further comprise instructions that, when executed, direct the computing device to maintain, for the tenant, contextual tenancy information comprising one or more of an entity type of the tenant and previous relationships between the application service and the tenant; and
the program instructions directing the computing device to determine the maximum value for the object lock retention date further comprise instructions that, when executed, direct the computing device to determine a maximum value for the object lock retention date further based on the contextual tenancy information.

20. A method of operating a storage controller, the method comprising:
storing objects in a storage volume associated with a tenant of an application service;
receiving a request to configure a retention date for at least an object in the storage volume associated with the tenant of the application service;
determining which mode, of at least a compliance mode and a governance mode, is enabled for the storage volume;
in response to determining that the compliance mode is enabled:
determining a maximum value for the retention date based on a service-expiration date associated with a tenancy of the tenant with respect to the application service;
setting the retention date less than or equal to maximum value; and
in response to determining that the governance mode is enabled for the storage volume, allowing the retention date to be configured for a date beyond the maximum value.
